(19) United States
(12) Patent Application Publication
(10) Pub. No.: US 2021/0208866 A1
(43) Pub. Date: Jul. 8, 2021

(54) SOFTWARE DEPENDENCY AND COMPLIANCE

(71) Applicant: IGT, Las Vegas, NV (US)

(72) Inventor: Ethan EDSALL, Sparks, NV (US)

(21) Appl. No.: 16/733,725

(22) Filed: Jan. 3, 2020

(51) Int. Cl. G06F 8/65; G06F 8/71

(52) U.S. Cl. CPC G06F 8/65; G06F 8/71

(57) ABSTRACT

A server includes a processor circuit and a memory coupled to the processor circuit. The memory includes computer program instructions that, when executed by the processor circuit, cause the server to perform operations of receiving installed version data corresponding to multiple software applications that are installed on an electronic gaming machine (EGM), comparing the installed version data to a compliant version data file that is external to the EGM, identifying, based on the comparing, a first software application of the software applications that is non-compliant and responsive to identifying the first software application as non-compliant, automatically performing a remedial operation that corresponds to the first software application.

### FIELD

Embodiments described herein relate to systems, methods and computer program products providing and updating multiple software types and instances files.

### BACKGROUND OF THE DISCLOSURE

Electronic devices may include memory and processor circuits that are configured to store and execute computer readable program code to performed various operations thereof. Many such devices are operable to incorporate multiple different software programs that include respective portions of the computer readable program code. Different ones of the software applications may be selectively updated as new versions thereof become available. In such cases, compatibility issues may arise based on newly updated software applications if other software applications are not updated when new versions become available.

Compatibility issues may include reduced functionality of the software applications and/or unsupported features in certain software applications. Compatibility issues may also include reduced functionality of hardware within the devices. Additionally, compatibility issues may cause installed software applications to become out of compliance with the rules corresponding to one or more regulatory agencies and/or with previously executed legal requirements, such as contracts and/or licenses.

### BRIEF SUMMARY OF THE DISCLOSURE

Some embodiments herein are directed to a server that includes a processor circuit and a memory coupled to the processor circuit. The memory includes computer program instructions that, when executed by the processor circuit, cause the server to perform operations including receiving installed version data corresponding to multiple software applications that are installed on an EGM, comparing the installed version data to a compliant version data file that is external to the EGM, identifying, based on the comparing, a first software application of the software applications that is non-compliant, and, responsive to identifying the first software application as non-compliant, automatically performing a remedial operation that corresponds to the first software application.

Some embodiments herein are directed to methods that include transmitting, to an EGM, a message that includes a request for installed version data corresponding to software applications that are installed on the EGM, receiving the installed version data that includes installed checksum values corresponding to the software applications, and comparing the installed checksum values to corresponding checksum values in a compliant version data file that is external to the EGM. Based on the comparing, operations may include identifying a first software application of the software applications that is non-compliant and, responsive to identifying the first software application as non-compliant, automatically performing a remedial operation that corresponds to the first software application.

Some embodiments herein are directed to a dependency/compliance server that includes a processor circuit and a memory coupled to the processor circuit. The memory may include computer program instructions that, when executed by the processor circuit, cause the dependency/compliance server to perform operations including receiving installed version data corresponding to multiple software applications that are installed on an EGM, comparing the installed version data to a compliant version data file that is external to the EGM, identifying, based on the comparing, a first software application of the software applications that is non-compliant, and, responsive to identifying the first software application as non-compliant, automatically generating an alert message and causing the alert message to be transmitted to an operator of the EGM.

### BRIEF DESCRIPTION OF THE DRAWINGS

FIG. 1 is a schematic block diagram illustrating a system according to some embodiments.

FIG. 2 is a schematic block diagram illustrating a system including a according to some embodiments.

FIGS. 3-6 are flowcharts illustrating operations of systems/methods according to some embodiments.

FIG. 7 is a block diagram that illustrates various components of a dependency/compliance server according to some embodiments.

FIG. 8A is a perspective view of an EGM illustrating various physical features of the device that can be configured according to some embodiments.

FIG. 8B is a schematic block diagram illustrating an electronic configuration for a gaming device according to some embodiments.

FIG. 8C is a schematic block diagram illustrating a memory device of FIGS. 8A and 8B according to some embodiments.

### DETAILED DESCRIPTION OF THE DISCLOSURE

Embodiments of the inventive concepts provide software dependency and compliance methods, devices and systems that may provide functionality for devices such as EGMs to relay information about their software and/or firmware versions to a central information hub. Based on the received information, automated recommendations can be provided to an operator and/or automated actions may be performed to minimize downtime and compatibility issues with the devices and/or a casino management system.

Casino management systems herein may include many software and hardware components that may have version dependencies to function properly with other software and/or hardware components on a gaming floor. In addition to providing compliance corresponding to different jurisdictions, concepts disclosed herein may provide for successful operation of all features of the overall casino management system. In this manner, a technical solution of providing software dependency and compliance as disclosed herein may ensure compliance with the latest submissions of software applications, and/or ensure that the gaming floor devices have the correct software to operate successfully. Moreover, such methods, devices and systems may address the technical problem of having unwanted outages of devices resulting from outdated and/or incompatible software application versions.

In some embodiments of a software dependency and compliance approach, software applications may exist on each EGM and each EGM may communicate back to a central hub. The central hub may include a dependency/compliance server that includes and/or is operable to retrieve all of the versions of software and/or hardware that are running on the EGMs. This information may be stored into a database. On the central system side, a user may upload a compliant version data file that specifies what that operator needs to be compliant and have all submitted features function for that operator. The versions of firmware and/or software applications may be compared to the compliant version data file. In some embodiments, a report may be generated to notify the operator of any devices on the gaming floor that include non-compliant versions of firmware and/or software applications. In some embodiments, the system may automatically enforce updates for the non-compliant firmware and/or software applications on their respective devices. In some embodiments, the automatic update may be performed at a scheduled time. Some embodiments provide that the update may be based on an approval received from the operator. In this manner, compliance and dependency issues may be identified and options for automating a correction thereof may be provided. Embodiments herein may be applicable to peripheral firmware, EGM operating systems, game themes, game features, and/or other software applications and/or packages thereof.

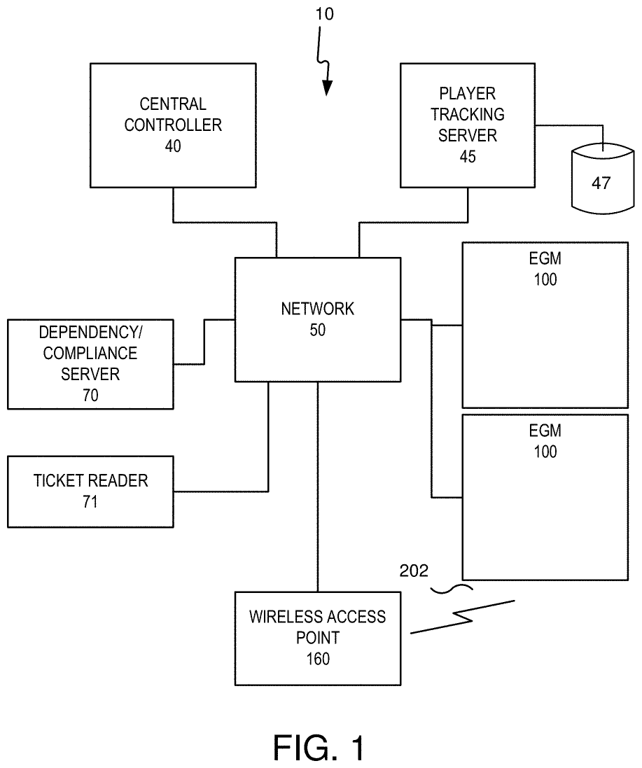

Reference is now made to FIG. 1, which is a schematic block diagram illustrating a system 10 including a plurality of EGMs 100 is illustrated according to some embodiments. The system 10 may be located, for example, on the premises of a gaming establishment, such as a casino. The EGMs 100, which are typically situated on a casino floor, may be in communication with each other and/or at least one central controller 40 through a data network or remote communication link 50. The data communication network 50 may be a private data communication network that is operated, for example, by the gaming facility that operates the EGM 100.

Communications over the data communication network 50 may be encrypted for security. The central controller 40 may be any suitable server or computing device which includes at least one processor and at least one memory or storage device. Each EGM 100 may include a processor that transmits and receives events, messages, commands or any other suitable data or signal between the EGM 100 and the central controller 40. The EGM processor is operable to execute such communicated events, messages or commands in conjunction with the operation of the EGM. Moreover, the processor of the central controller 40 is configured to transmit and receive events, messages, commands or any other suitable data or signal between the central controller 40 and each of the individual EGMs 100. In some embodiments, one or more of the functions of the central controller 40 may be performed by one or more EGM processors. Moreover, in some embodiments, one or more of the functions of one or more EGM processors as disclosed herein may be performed by the central controller 40.

A wireless access point 160 provides wireless access to the data communication network 50. The wireless access point 160 may be connected to the data communication network 50 as illustrated in FIG. 1, or, may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

In some embodiments, the system 10 includes a dependency/compliance server 70. The dependency/compliance server 70 may be in direct and/or indirect communication with the system 10. For example, the dependency/compliance server 70 may be a computing system that communicates through the data communication network 50 with the EGMs 100 to receive installed version data corresponding to software applications that are installed on one or more of the EGMs 100. In some embodiments, the installed version data is received in response to a request that is made to the EGMs 100. The dependency/compliance server 70 may be implemented within or separately from the central controller 40.

The dependency/compliance server 70 may be configured to receive a compliant version data file that includes version and/or compliance data that corresponds to firmware and/or software applications that should be operating on a particular EGM 100. The dependency/compliance server 70 may further receive installed version data corresponding to EGMs 100 that may be compared with the contents of the compliant version data file to identify software applications that are not compliant relative to the compliant version data file. As such, the dependency/compliance server 70 may perform operations described herein for providing software dependency and compliance.

In some embodiments, the dependency/compliance server 70 may communicate directly and/or indirectly with an EGM 100 over a wireless interface 202, which may be a WiFi link, a Bluetooth link, an NFC link, etc. In other embodiments, the dependency/compliance server 70 may communicate with the data communication network 50 (and devices connected thereto, including EGMs) over a wireless interface 202 with the wireless access point 160.

In some embodiments, operations corresponding to the dependency/compliance server 70, the central controller 40 and/or the EGM 100 may be performed by a server that includes a processing device and a memory. The memory may be configured to store computer readable instructions that, when executed, cause the processing device to perform operations described herein.

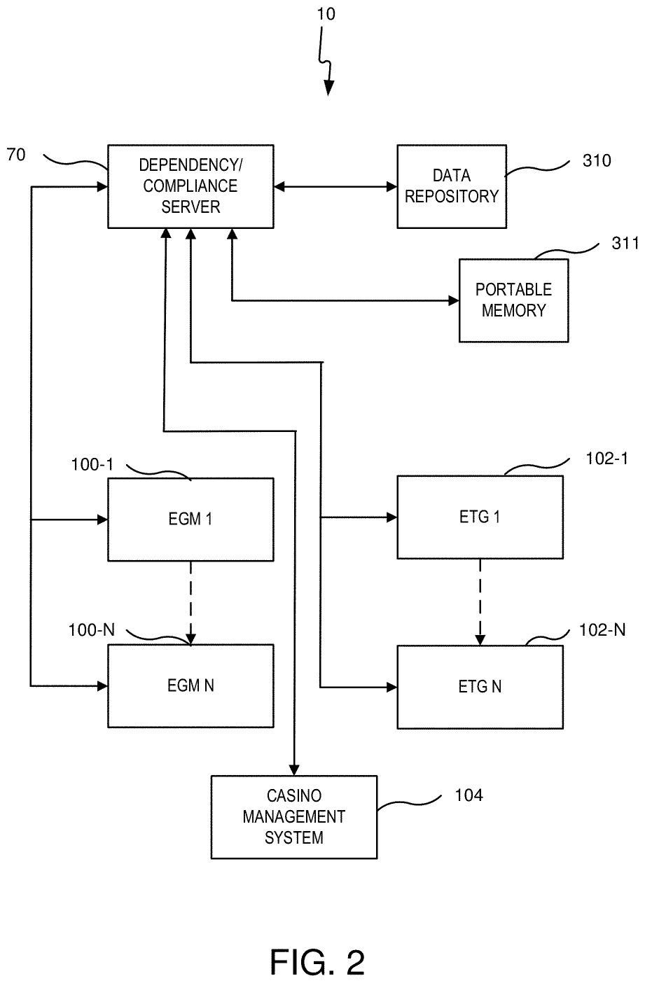

Reference is now made to FIG. 2, which is a schematic block diagram illustrating a system 10 including EGMs 100, ETGs 102 and a casino management system 104 according to some embodiments. Numerous components in the embodiments described above with reference FIG. 1 for elements to communicatively couple the dependency/compliance server 70, EGTs 100, ETGs 102, a casino management system 104 and/or a data repository 310 may be included in these embodiments without repeated discussion thereof. The system 10 may be located, for example, on the premises of a gaming establishment, such as a casino. The EGMs 100-100 N, which are typically situated on a casino floor, may be in communication with each other and/or a dependency/compliance server 70. The ETGs 102-102 N, which are typically situated on a casino floor, may be in communication with each other and/or a dependency/compliance server 70. Additionally, a casino management system 104 may be local to the casino and/or may be located off site relative to the casino and may be in communication with a dependency/compliance server 70.

In some embodiments, the system 10 includes a dependency/compliance server 70. In some embodiments, the installed version data is received in response to a request that is made to the EGMs 100, ETGs 102, and/or the casino management system 104.

The dependency/compliance server 70 may be configured to receive a compliant version data file that includes version and/or compliance data that corresponds to which firmware and/or software applications that should be on a particular EGM 100, ETG 102, and/or casino management system 104. The dependency/compliance server 70 may further receive installed version data corresponding to EGMs 100, ETGs 102 and/or casino management system 104 that may be compared with the contents of the compliant version data file to identify software applications that are not compliant relative to the compliant version data file. As such, the dependency/compliance server 70 may perform operations described herein for providing software dependency and compliance.

In some embodiments, the dependency/compliance server 70 may communicate directly and/or indirectly with an EGM 100, ETG 102, and/or casino management system 104 over any number of wireless and/or wired interfaces, as described herein.

In some embodiments, communication between the dependency/compliance server 70 and any of the EGMs 100, ETGs 102, and/or casino management system 104 may not rely on wireless and/or wired interfaces and may use a portable memory 311 to transmit installed version data and/or an updated software application to replace non-compliant software applications. Examples of a portable memory 311 include any portable devices that include memory for storing computer readable program code. The portable memory may be configured to store computer readable instructions that, when executed, cause a processing device to perform operations described herein.

In such embodiments, receiving installed version data corresponding to software applications includes reading a first computer readable storage device that includes the installed version data. In such embodiments, automatically performing a remedial operation includes providing a second computer readable storage device that includes an updated software application that is a compliant software application.

Although, many embodiments described herein may be directed to software applications on EGM's 100, operations described herein are equally applicable to ETGs 102 and/or casino management systems 104 and/or components thereon.

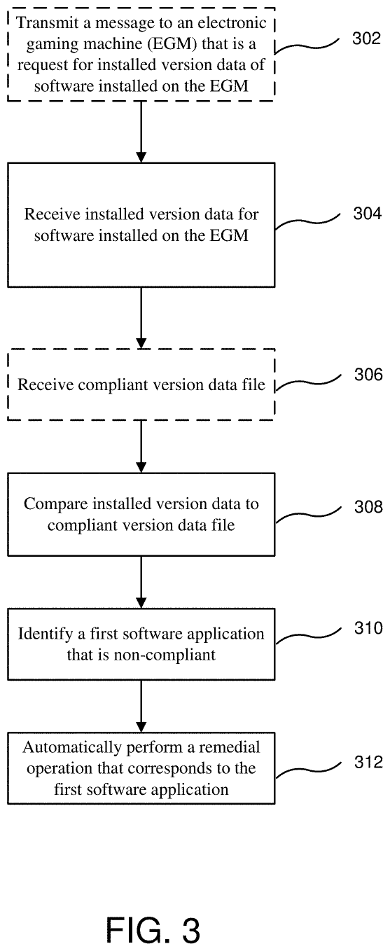

Reference is now made to FIGS. 3-6, which are flowcharts illustrating operations of systems/methods/devices according to some embodiments. For example, some embodiments provide that such operations are performed by a dependency/compliance server 70. Referring now to FIG. 3, operations include receiving installed version data corresponding to multiple software applications that are installed on an EGM (block 304). Some embodiments provide that, before receiving the installed version data, operations include optionally transmitting a message to the EGM that includes a request for the installed version data (block 302). In some embodiments, the installed version data is received from an EGM based on a scheduled transmission. For example, the EGM may be configured to send the installed version data at some previously defined date/time and/or periodically at a given time interval. In some embodiments, the EGM may send the installed version data in response to an event, such as an event that occurs at the EGM. For example, the EGM may receive a particular type of input from an operator and/or operator system that triggers the EGM to transmit the installed version data. In some embodiments, the EGM may transmit the installed version data responsive to an internal condition at the EGM such as a detected fault and/or other type condition.

In some embodiments, a compliant version data file may be obtained and/or accessed by the dependency/compliance server 70. For example, some embodiments provide that the compliant version data file may be stored locally on the dependency/compliance server 70. In some embodiments, the compliant version data file may be stored in a device other than the dependency/compliance server 70 and that may be located external to the dependency/compliance server 70. In such embodiments, the dependency/compliance server 70 may request the compliant version data file from the external source, such as, for example, a data repository, and may optionally receive the compliant version data file (block 306). In some embodiments, the compliant version data file includes a software application compatibility matrix that identifies compatibility corresponding to versions of the multiple different software applications that may be installed on the EGM. In some embodiments, the compliant version data file comprises version data corresponding to multiple different EGMs and thus can be used to determine software dependency and/or compliance for multiple different EGMs. Some embodiments provide that compatibility corresponding to the multiple software applications includes dependency data among different ones of the software applications.

The installed version data may be compared to a compliant version data file (block 308). Operations include identifying, based on the comparing, a first software application of the multiple software applications that is non-compliant (block 310). In some embodiments, the installed version data of the first software application includes a first checksum value and the compliant version data file includes a second checksum value that was previously stored in the compliant version data file and that corresponds the first software application. In such embodiments, identifying the first software application as non-compliant may be based on determining that the first checksum value is different than the second checksum value.

In some embodiments, the installed version data of the first software application includes a first version identifier and the compliant version data file includes a second version identifier that was previously stored in the compliant version data file and that corresponds to the first software application. In such embodiments, identifying the first software application as non-compliant includes determining that the first software application is not a current version based on the first version identifier being different from the second version identifier.

Operations further include, responsive to identifying the first software application as non-compliant, automatically performing a remedial operation that corresponds to the first software application (block 312). In some embodiments, automatically performing the remedial operation includes generating an action message that includes information corresponding to the first software application and defines an action that will be automatically performed and transmitting the action message to a recipient. The recipient may include a responsible party and/or user corresponding to the EGM and/or casino management systems, among others. In some embodiments, the action message includes an opt out input that, responsive to actuation by the recipient, causes a delay in automatically performing the action.

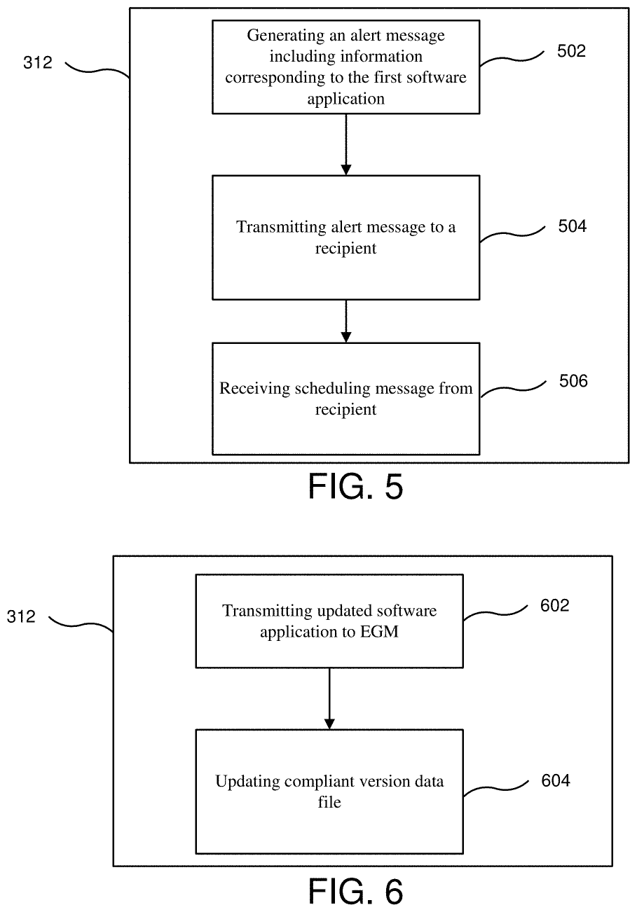

Brief reference is made to FIG. 5, which is a schematic block diagram that illustrates example operations of automatically performing the remediation operation (block 312). In some embodiments, automatically performing the remedial operation includes generating an alert message that includes information corresponding to the first software application (block 502). For example, such information may include a checksum value, product name, product type, build date, install date, a version number and/or a date range that defines the time interval during which the software application instance is valid, among others.

Some embodiments include transmitting the alert message to a recipient, such as a casino or other operator (block 504). In this manner, a casino operator may be informed regarding any software applications that are not compliant and/or that version dependency issues exist. In some embodiments, the alert message may include information corresponding to functions that may be unavailable based on the lack of compliance and/or version dependency issues.

Some embodiments include receiving, from the recipient, a scheduling message (block 506). The scheduling message may include data that identifies a scheduled time for the first software application to be updated in the EGM to be compliant.

Brief reference is made to FIG. 6, which is a schematic block diagram that illustrates example operations of automatically performing the remediation operation (block 312). In some embodiments, automatically performing the remedial operation includes transmitting an updated software application to the EGM (block 602). The updated software application may replace the first software application with the updated software application that is a compliant software application. Some embodiments include updating the compliant version data file to include data corresponding to updated software application (block 604).

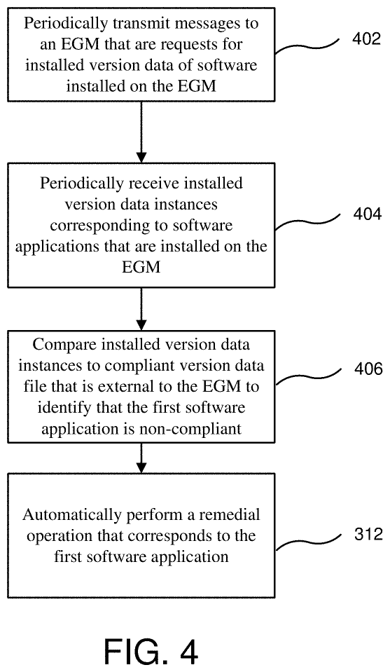

Reference is made to FIG. 4, which is a schematic block diagram that illustrates example operations according to some embodiments. Operations include periodically transmitting multiple messages to the EGM, each of the messages may include a request for a corresponding installed version data instance (block 402). In some embodiments, operations may include periodically receiving installed version data instances corresponding to the software applications that are installed on the EGM (block 404). Some embodiments provide that operations include comparing each of the installed version data instances to the compliant version data file that is external to the EGM to identify that the first software application is non-compliant (block 406). Some embodiments may further provide that a remedial operation that corresponds to the first software application that is non-compliant is automatically performed (block 312).

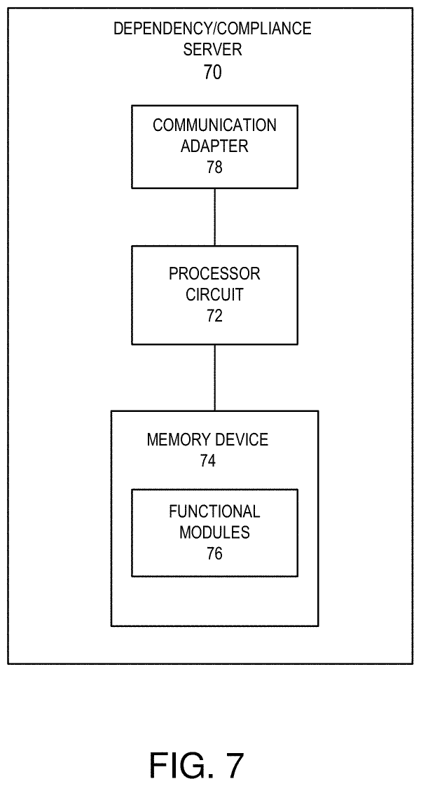

Reference is now made to FIG. 7, is a block diagram that illustrates various components of a dependency/compliance server 70 according to some embodiments. As shown in FIG. 7, the dependency/compliance server 70 may include a processor circuit 72 that controls operations of the dependency/compliance server 70. Although illustrated as a single processor, multiple special purpose and/or general purpose processors and/or processor cores may be provided in the dependency/compliance server 70. For example, the dependency/compliance server 70 may include one or more of a video processor, a signal processor, a sound processor and/or a communication controller that performs one or more control functions therein. The processor 72 may be variously referred to as a “controller,” “microcontroller,” “microprocessor” or simply a “computer.” The processor may further include one or more application-specific integrated circuits (ASICs).

Various components of the dependency/compliance server 70 are illustrated in FIG. 7 as being connected to the processor circuit 72. It will be appreciated that the components may be connected to the processor circuit 72 through a system bus, a communication bus and controller, such as a USB controller and USB bus, a network interface, or any other suitable type of connection.

The dependency/compliance server 70 further includes a memory device 74 that stores one or more functional modules 76 for performing the operations described above.

The memory device 74 may store program code and instructions, executable by the processor circuit 72, to control the dependency/compliance server 70. The memory device 74 may include random access memory (RAM), which can include non-volatile RAM (NVRAM), magnetic RAM (ARAM), ferroelectric RAM (FeRAM) and other forms as commonly understood in the gaming industry. In some embodiments, the memory device 74 may include read only memory (ROM). In some embodiments, the memory device 74 may include flash memory and/or EEPROM (electrically erasable programmable read only memory). Any other suitable magnetic, optical and/or semiconductor memory may operate in conjunction with the gaming device disclosed herein.

The dependency/compliance server 70 may include a communication adapter 78 that enables the dependency/compliance server 70 to communicate with remote devices, such as EGMs 100 and/or a player tracking server over a wired and/or wireless communication network, such as a local area network (LAN), wide area network (WAN), cellular communication network, or other data communication network.

The dependency/compliance server 70 may include one or more internal or external communication ports that enable the processor circuit 72 to communicate with and to operate with internal or external peripheral devices, such as display screens, keypads, mass storage devices, microphones, speakers, and wireless communication devices. In some embodiments, internal or external peripheral devices may communicate with the processor through a universal serial bus (USB) hub (not shown) connected to the processor circuit 72.

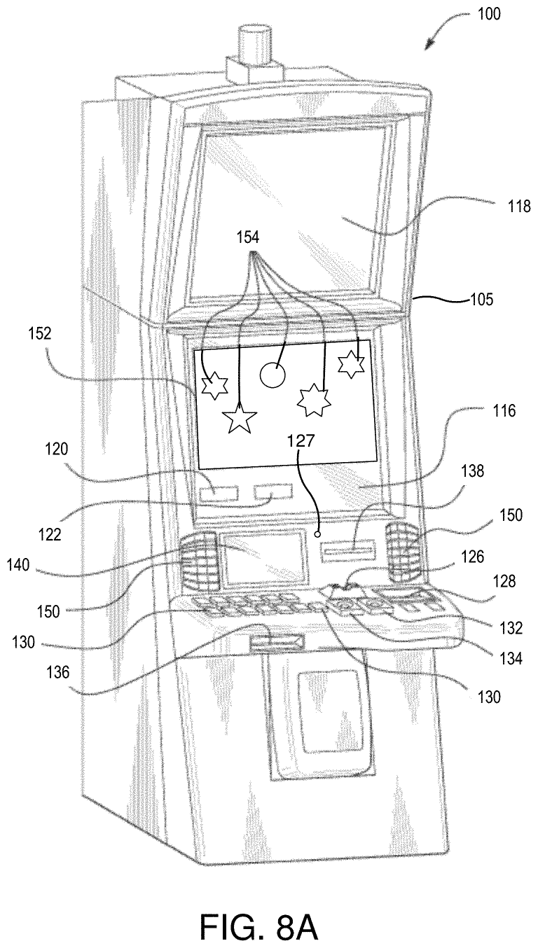

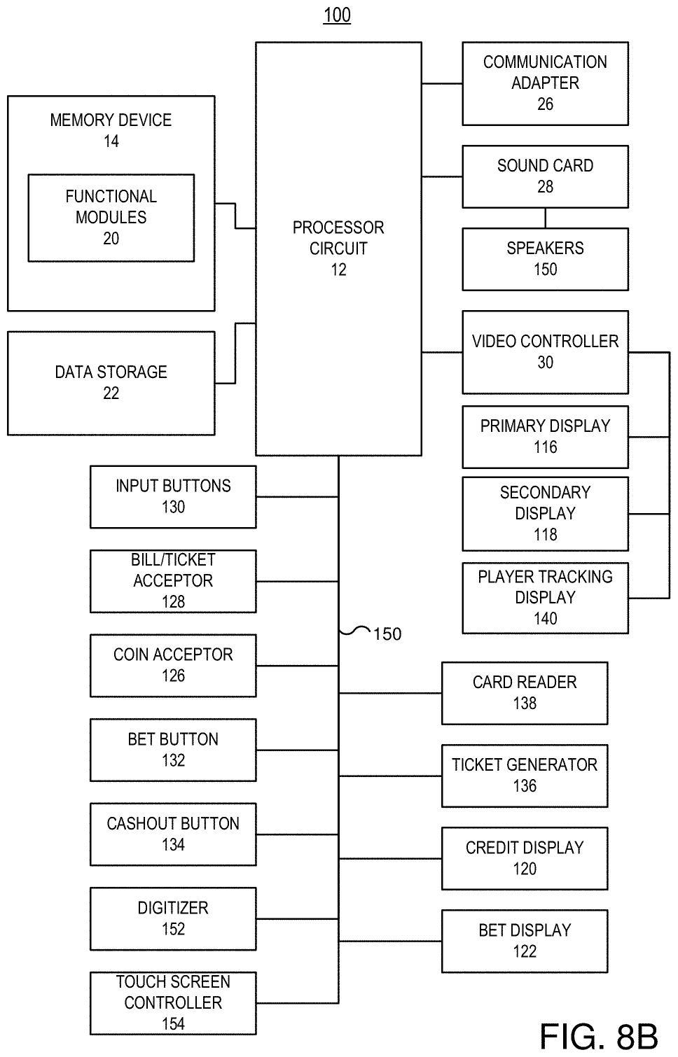

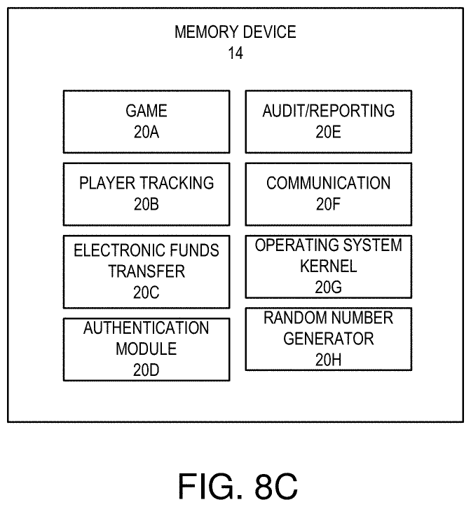

An example of an electronic gaming machine (EGM) that can include firmware and software versions that may be evaluated according to embodiments herein according to various embodiments is illustrated in FIGS. 8A and 8B in which FIG. 8A is a perspective view of an EGM 100 illustrating various physical features of the device and FIG. 8B is a functional block diagram that schematically illustrates an electronic relationship of various elements of the EGM 100. The embodiments shown in FIGS. 8A and to 8B are provided as examples for illustrative purposes only. It will be appreciated that EGMs may come in many different shapes, sizes, layouts, form factors, and configurations, and with varying numbers and types of input and output devices, and that embodiments of the inventive concepts are not limited to the particular EGM structures described herein.

EGMs typically include a number of standard features, many of which are illustrated in FIGS. 8A and 8B. For example, referring to FIG. 8A, an EGM 100 may include a support structure, housing or cabinet 105 which provides support for a plurality of displays, inputs, outputs, controls and other features that enable a player to interact with the EGM 100.

The EGM 100 illustrated in FIG. 8A includes a number of display devices, including a primary display device 116 located in a central portion of the cabinet 105 and a secondary display device 118 located in an upper portion of the cabinet 105. It will be appreciated that one or more of the display devices 116, 118 may be omitted, or that the display devices 116, 118 may be combined into a single display device. The EGM 100 may further include a player tracking display 140, a credit display 120, and a bet display 122. The credit display 120 displays a player's current number of credits, cash, account balance or the equivalent. The bet display 122 displays a player's amount wagered.

The player tracking display 140 may be used to display a service window that allows the player to interact with, for example, their player loyalty account to obtain features, bonuses, comps, etc. In other embodiments, additional display screens may be provided beyond those illustrated in FIG. 8A.

The EGM 100 may further include a number of input devices that allow a player to provide various inputs to the EGM 100, either before, during or after a game has been played. For example, the EGM 100 may include a plurality of input buttons 130 that allow the player to select options before, during or after game play. The EGM 100 may further include a game play initiation button 132 and a cashout button 134. The cashout button 134 is utilized to receive a cash payment or any other suitable form of payment corresponding to a quantity of remaining credits of a credit display.

In some embodiments, one or more input devices of the EGM 100 are one or more game play activation devices that are each used to initiate a play of a game on the EGM 100 or a sequence of events associated with the EGM 100 following appropriate funding of the EGM 100. The example EGM 100 illustrated in FIGS. 8A and 8B includes a game play activation device in the form of a game play initiation button 132. It should be appreciated that, in other embodiments, the EGM 100 begins game play automatically upon appropriate funding rather than upon utilization of the game play activation device.

In some embodiments, one or more input devices of the EGM 100 are one or more wagering or betting devices. One such wagering or betting device is as a maximum wagering or betting device that, when utilized, causes a maximum wager to be placed. Another such wagering or betting device is a repeat the bet device that, when utilized, causes the previously-placed wager to be placed. A further such wagering or betting device is a bet one device. A bet is placed upon utilization of the bet one device. The bet is increased by one credit each time the bet one device is utilized. Upon the utilization of the bet one device, a quantity of credits shown in a credit display (as described below) decreases by one, and a number of credits shown in a bet display (as described below) increases by one.

In some embodiments, one or more of the display screens may have a touch-sensitive display that includes a digitizer 152 and a touchscreen controller 154 (FIG. 8B). The player may interact with the EGM 100 by touching virtual buttons on one or more of the display devices 116, 118, 140. Accordingly, any of the above described input devices, such as the input buttons 130, the game play initiation button, which may also be referred to as a “Bet Button”, 132 and/or the cashout button 134 may be provided as virtual buttons on one or more of the display devices 116, 118, 140.

Referring briefly to FIG. 8B, operation of the primary display device 116, the secondary display device 118 and the player tracking display 140 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30.

Referring again to FIG. 8A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touch-screen with an associated touch-screen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the EGM 100 are generally configured to display one or more game and/or non-game images, symbols, and indicia. In certain embodiments, the display devices 116, 118, 140 of the EGM 100 are configured to display any suitable visual representation or exhibition of the movement of objects; dynamic lighting; video images; images of people, characters, places, things, and faces of cards; and the like. In certain embodiments, the display devices 116, 118, 140 of the EGM 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The EGM 100 also includes various features that enable a player to deposit credits in the EGM 100 and withdraw credits from the EGM 100, such as in the form of a payout of winnings, credits, etc. For example, the EGM 100 may include multiple different physical devices that are operable to receive monetary value from the player. In some embodiments, such devices include a ticket dispenser 136, a bill/ticket acceptor 128, and a coin acceptor 126 that allows the player to deposit coins into the EGM 100.

While not illustrated in FIG. 8A, the EGM 100 may also include a note dispenser configured to dispense paper currency and/or a coin generator configured to dispense coins or tokens in a coin payout tray.

The EGM 100 may further include one or more speakers 150 controlled by one or more sound cards 28 (FIG. 8B). The EGM 100 illustrated in FIG. 8A includes a pair of speakers 150. In other embodiments, additional speakers, such as surround sound speakers, may be provided within or on the cabinet 105. Moreover, the EGM 100 may include built-in seating with integrated headrest speakers.

In various embodiments, the EGM 100 may generate dynamic sounds coupled with attractive multimedia images displayed on one or more of the display devices 116, 118, 140 to provide an audio-visual representation or to otherwise display full-motion video with sound to attract players to the EGM 100 and/or to engage the player during gameplay. In certain embodiments, the EGM 100 may display a sequence of audio and/or visual attraction messages during idle periods to attract potential players to the EGM 100. The videos may be customized to provide any appropriate information.

The EGM 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor determines the amount of funds entered and displays the corresponding amount on the credit or other suitable display as described above.

In some embodiments, the EGM 100 may include an electronic payout device or module configured to fund an electronically recordable identification card or smart card or a bank or other account via an electronic funds transfer to or from the EGM 100.

FIG. 8B is a block diagram that illustrates logical and functional relationships between various components of an EGM 100. As shown in FIG. 8B, the EGM 100 may include a processor circuit 12 that controls operations of the EGM 100. Although illustrated as a single processor, multiple special purpose and/or general purpose processors and/or processor cores may be provided in the EGM 100. For example, the EGM 100 may include one or more of a video processor, a signal processor, a sound processor and/or a communication controller that performs one or more control functions within the EGM 100. The processor circuit 12 may be variously referred to as a “controller,” “microcontroller,” “microprocessor” or simply a “computer.” The processor may further include one or more application-specific integrated circuits (ASICs).

Various components of the EGM 100 are illustrated in FIG. 8B as being connected to the processor circuit 12. It will be appreciated that the components may be connected to the processor circuit 12 through a system bus, a communication bus and controller, such as a USB controller and USB bus, a network interface, or any other suitable type of connection.

The EGM 100 further includes a memory device 14 that stores one or more functional modules. The memory device 14 may store program code and instructions, executable by the processor circuit 12, to control the EGM 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The EGM 100 may further include a data storage device 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The EGM 100 may include a communication adapter 26 that enables the EGM 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the EGM 100 to communicate, for example, with a mobile communication device operated by a player.

The EGM 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor through a universal serial bus (USB) hub (not shown) connected to the processor circuit 12.

In some embodiments, the EGM 100 may include a sensor, such as a camera in communication with the processor circuit 12 (and possibly controlled by the processor circuit 12) that is selectively positioned to acquire an image of a player actively using the EGM 100 and/or the surrounding area of the EGM 100. In one embodiment, the camera may be configured to selectively acquire still or moving (e.g., video) images and may be configured to acquire the images in either an analog, digital or other suitable format. The display devices 116, 118, 140 may be configured to display the image acquired by the camera as well as display the visible manifestation of the game in split screen or picture-in-picture fashion. For example, the camera may acquire an image of the player and the processor circuit 12 may incorporate that image into the primary and/or secondary game as a game image, symbol or indicia.

Various functional modules of that may be stored in a memory device 14 of an EGM 100 are illustrated in FIG. 8C. Referring to FIG. 8C, the EGM 100 may include in the memory device 14 a game module 20A that includes program instructions and/or data for operating a hybrid wagering game as described herein. The EGM 100 may further include a player tracking module 20B, an electronic funds transfer module 20C, an authentication module 20D, an audit/reporting module 20E, a communication module 20F, an operating system 20G and a random number generator 20H. The player tracking module 20B keeps track of the play of a player. The electronic funds transfer module 20C communicates with a back end server or financial institution to transfer funds to and from an account associated with the player. The authentication module 20D may perform authentication of image files and provide checksum and/or version values for use by a dependency/compliance server as described in more detail herein. The communication module 20F enables the EGM 100 to communicate with remote servers and other EGMs using various secure communication interfaces. The operating system kernel 20G controls the overall operation of the EGM 100, including the loading and operation of other modules. The random number generator 20H generates random or pseudorandom numbers for use in the operation of the hybrid games described herein.

Embodiments described herein may be implemented in various configurations for EGMs 100s, including but not limited to: (1) a dedicated EGM, wherein the computerized instructions for controlling any games (which are provided by the EGM) are provided with the EGM prior to delivery to a gaming establishment; and (2) a changeable EGM, where the computerized instructions for controlling any games (which are provided by the EGM) are downloadable to the EGM through a data network when the EGM is in a gaming establishment. In some embodiments, the computerized instructions for controlling any games are executed by at least one central server, central controller or remote host. In such a “thin client” embodiment, the central server remotely controls any games (or other suitable interfaces) and the EGM is utilized to display such games (or suitable interfaces) and receive one or more inputs or commands from a player. In another embodiment, the computerized instructions for controlling any games are communicated from the central server, central controller or remote host to a EGM local processor and memory devices. In such a “thick client” embodiment, the EGM local processor executes the communicated computerized instructions to control any games (or other suitable interfaces) provided to a player.

In some embodiments, an EGM may be operated by a mobile device, such as a mobile telephone, tablet other mobile computing device.

In some embodiments, one or more EGMs in a gaming system may be thin client EGMs and one or more EGMs in the gaming system may be thick client EGMs. In another embodiment, certain functions of the EGM are implemented in a thin client environment and certain other functions of the EGM are implemented in a thick client environment. In one such embodiment, computerized instructions for controlling any primary games are communicated from the central server to the EGM in a thick client configuration and computerized instructions for controlling any secondary games or bonus functions are executed by a central server in a thin client configuration.

Some embodiments herein are directed to methods that include transmitting, to an EGM, a message that includes a request for installed version data corresponding to software applications that are installed on the EGM, receiving the installed version data that includes installed checksum values corresponding to the software applications, and comparing the installed checksum values to corresponding checksum values in a compliant version data file that is external to the EGM. Based on the comparing, operations may include identifying a first software application of the software applications that is non-compliant and, responsive to identifying the first software application as non-compliant, automatically performing a remedial operation that corresponds to the first software application.

In some embodiments, the compliant version data file includes a stored checksum value that was previously stored in the compliant version data file and that corresponds the first software application and identifying the first software application as non-compliant includes determining that the installed checksum value is different than the stored checksum value.

In some embodiments, receiving the installed version data includes periodically receiving installed version data instances corresponding to the software applications that are installed on the EGM. In such embodiments, the comparing operation includes comparing each of the installed version data instances to the compliant version data file that is external to the EGM to identify the first software application that is non-compliant.

Some embodiments provide that automatically performing the remedial operation further includes receiving, from a recipient, a scheduling message that includes data that identifies a scheduled time for the first software application to be updated to be compliant.

In some embodiments, the compliant version data file includes a software application compatibility matrix that identifies compatibility corresponding to versions of the software applications and the compatibility corresponding to the software applications includes dependency data among different ones of the software applications.

Some embodiments herein are directed to a dependency/compliance server that includes a processor circuit and a memory coupled to the processor circuit. The memory may include computer program instructions that, when executed by the processor circuit, cause the dependency/compliance server to perform operations including receiving installed version data corresponding to multiple software applications that are installed on an EGM, comparing the installed version data to a compliant version data file that is external to the EGM, identifying, based on the comparing, a first software application of the software applications that is non-compliant, and, responsive to identifying the first software application as non-compliant, automatically generating an alert message and causing the alert message to be transmitted to an operator of the EGM.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more EGMs; and/or (c) one or more personal EGMs, such as desktop computers, laptop computers, tablet computers or computing devices, personal digital assistants (PDAs), mobile telephones such as smart phones, and other mobile computing devices.

In certain such embodiments, computerized instructions for controlling any games (such as any primary or base games and/or any secondary or bonus games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processor of the EGM executes the computerized instructions to control any games (or other suitable interfaces) displayed by the EGM.

In some embodiments in which the gaming system includes: (a) an EGM configured to communicate with a central server, central controller, or remote host through a data network; and/or (b) a plurality of EGMs configured to communicate with one another through a data network, the data network is an internet or an intranet. In certain such embodiments, an internet browser of the EGM is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the EGM.

It should be appreciated that the central server, central controller, or remote host and the EGM are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of EGMs to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a non-transitory computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. Therefore, it is to be understood that the foregoing is illustrative of the present inventive concept and is not to be construed as limited to the embodiments disclosed herein, and that modifications to the disclosed embodiments, as well as other embodiments, are intended to be included within the scope of the appended claims. The present inventive concept is defined by the following claims.

What is claimed is:

1. A server comprising:
a processor circuit; and
a memory coupled to the processor circuit, wherein the memory comprises computer program instructions that, when executed by the processor circuit, cause the server to perform operations comprising:
receiving installed version data corresponding to a plurality of software applications that are installed on an electronic gaming machine (EGM);
comparing the installed version data to a compliant version data file that is external to the EGM;
identifying, based on the comparing, a first software application of the plurality of software applications that is non-compliant; and
responsive to identifying the first software application as non-compliant, automatically performing a remedial operation that corresponds to the first software application.

2. The server of claim 1,
wherein the installed version data of the first software application comprises a first checksum value,
wherein the compliant version data file comprises a second checksum value that was previously stored in the compliant version data file and that corresponds the first software application;
wherein identifying the first software application as non-compliant comprises determining that the first checksum value is different than the second checksum value.

3. The server of claim 1,
wherein the installed version data of the first software application comprises a first version identifier;
wherein the compliant version data file comprises a second version identifier that was previously stored in the compliant version data file and that corresponds to the first software application; and
wherein identifying the first software application as non-compliant comprises determining that the first software application is not a current version based on the first version identifier being different from the second version identifier.

4. The server of claim 1, further comprising, before receiving the installed version data, transmitting a message to the EGM, the message comprising a request for the installed version data.

5. The server of claim 1, further comprising:
periodically receiving installed version data instances corresponding to the plurality of software applications that are installed on the EGM;
comparing each of the installed version data instances to the compliant version data file that is external to the EGM to identify that the first software application that is non-compliant.

6. The server of claim 5, further comprising, periodically transmitting a plurality of messages to the EGM, each of the plurality of messages comprising a request for corresponding installed version data instances.

7. The server of claim 1, wherein automatically performing the remedial operation comprises generating an alert message that comprises information corresponding to the first software application and transmitting the alert message to a recipient.

8. The server of claim 7, wherein automatically performing the remedial operation further comprises receiving, from the recipient, a scheduling message that comprises data that identifies a scheduled time for the first software application to be updated to be compliant.

9. The server of claim 1, wherein automatically performing the remedial operation comprises transmitting an updated software application to the EGM to replace the first software application with the updated software application that is a compliant software application.

10. The server of claim 9, further comprising updating the compliant version data file to comprise data corresponding to updated software application.

11. The server of claim 1, wherein automatically performing the remedial operation comprises generating an action message that comprises information corresponding to the first software application and defines an action that will be automatically performed and transmitting the action message to a recipient.

12. The server of claim 11, wherein the action message further comprises an opt out input that, responsive to actuation by the recipient, causes a delay in automatically the action.

13. The server of claim 1, wherein receiving installed version data corresponding to the plurality of software applications comprises reading a first computer readable storage device that includes the installed version data, and
wherein automatically performing the remedial operation comprises generating a second computer readable storage device that comprises an updated software application that is a compliant software application.

14. The server of claim 1, wherein the compliant version data file comprises a software application compatibility matrix that identifies compatibility corresponding to versions of the plurality of software applications, and
wherein the compatibility corresponding to the plurality of software applications comprises dependency data among different ones of the plurality of software applications.

15. A method, comprising:
transmitting, to an electronic gaming machine (EGM), a message that comprises a request for installed version data corresponding to a plurality of software applications that are installed on the EGM;
receiving the installed version data that comprises installed checksum values corresponding to the plurality of software applications;
comparing the installed checksum values to corresponding checksum values in a compliant version data file that is external to the EGM;
based on the comparing, identifying a first software application of the plurality of software applications that is non-compliant; and
responsive to identifying the first software application as non-compliant, automatically performing a remedial operation that corresponds to the first software application.

16. The method of claim 15,
wherein the compliant version data file comprises a stored checksum value that was previously stored in the compliant version data file and that corresponds the first software application, and
wherein identifying the first software application as non-compliant comprises determining that one of the installed checksum values is different than the stored checksum value.

17. The method of claim 15, wherein receiving the installed version data comprises periodically receiving installed version data instances corresponding to the plurality of software applications that are installed on the EGM, and
wherein the comparing comprises comparing each of the installed version data instances to the compliant version data file that is external to the EGM to identify the first software application that is non-compliant.

18. The method of claim 15, wherein automatically performing the remedial operation further comprises receiving, from a recipient, a scheduling message that comprises data that identifies a scheduled time for the first software application to be updated to be compliant.

19. The method of claim 15, wherein the compliant version data file comprises a software application compatibility matrix that identifies compatibility corresponding to versions of the plurality of software applications, and
wherein the compatibility corresponding to the plurality of software applications comprises dependency data among different ones of the plurality of software applications.

20. A dependency/compliance server comprising:
a processor circuit; and
a memory coupled to the processor circuit, wherein the memory comprises computer program instructions that, when executed by the processor circuit, cause the dependency/compliance server to perform operations comprising:
receiving installed version data corresponding to a plurality of software applications that are installed on an electronic gaming machine (EGM);
comparing the installed version data to a compliant version data file that is external to the EGM;
identifying, based on the comparing, a first software application of the plurality of software applications that is non-compliant; and
responsive to identifying the first software application as non-compliant, automatically generating an alert message and causing the alert message to be transmitted to an operator of the EGM.
